(19) United States
(12) Patent Application Publication
(10) Pub. No.: US 2016/0200141 A1
(43) Pub. Date: Jul. 14, 2016

(54) SULFUR-CROSSLINKABLE RUBBER MIXTURE

(71) Applicant: Continental Reifen Deutschland GmbH, Hannover (DE)

(72) Inventors: Katharina Herzog, Harsum (DE); Carla Recker, Hannover (DE); Juliane Jungk, Isernhagen (DE)

(21) Appl. No.: 15/074,672

(22) Filed: Mar. 18, 2016

Related U.S. Application Data
(63) Continuation of application No. PCT/EP2014/068785, filed on Sep. 4, 2014.

(30) Foreign Application Priority Data
Sep. 27, 2013 (EP) 13186371.4

(51) Int. Cl. B60C 1/00; B60C 13/00; B60C 11/00; C08L 9/06

(52) U.S. Cl. CPC B60C 1/0016; C08L 9/06; B60C 1/0025; B60C 13/00; B60C 11/0008; C08L 2205/025; C08L 2205/03; C08L 2312/00

(57) ABSTRACT

A sulfur-crosslinkable rubber mixture, in particular for vehicle tires, belts, straps and tubes is disclosed. The rubber mixture contains at least the following constituents: 50 to 95 phr of at least one solution-polymerized styrene-butadiene rubber which is amino-functionalized and has a styrene content of 0.1 to 12% by weight and which, when unvulcanized, has a glass transition temperature of −75 to −120° C. when measured by DSC, and 5 to 95 phr of at least one additional rubber and 20 to 150 phr of at least one carbon black.

### CROSS REFERENCE TO RELATED APPLICATIONS

This application is a continuation application of international patent application PCT/EP2014/068785, filed Sep. 4, 2014, designating the United States and claiming priority from European application 13186371.4, filed Sep. 27, 2013, and the entire content of both applications is incorporated herein by reference.

### FIELD OF THE INVENTION

The disclosure relates to a sulfur-crosslinkable rubber mixture, in particular for vehicle tires, straps, belts, and hoses.

### BACKGROUND OF THE INVENTION

The rubber composition of the tread determines the road properties of a tire, in particular a pneumatic vehicle tire, to a large extent. The rubber mixtures used mainly in the heavily mechanically stressed areas of belts, hoses and straps are also largely responsible for the stability and durability of these rubber articles. For this reason, the standards for these rubber mixtures for pneumatic vehicle tires, straps, belts, and hoses are very high.

There are conflicts of objectives between most of the known tire properties, for example wet grip performance, dry braking, rolling resistance, winter properties, abrasion performance, and tear properties. These properties are also important criteria for quality in technical rubber articles such as straps, belts, and hoses.

In vehicle tires in particular, a wide variety of attempts have been made to positively influence the properties of tires by varying polymer components, fillers, and other aggregates, particularly in the tread mixture.

It must here be borne in mind that an improvement in one tire property often causes worsening of another property.

In a given mixing system, for example, there are various known possibilities for optimizing rolling resistance. These include reducing the glass transition temperature of the rubber mixture, reducing the degree of filling and changing the polymer system. All of the aforementioned measures result in a decline in abrasion properties and/or wet grip properties and/or tear properties of the mixture in question.

In the present disclosure, the term vehicle tires is understood to refer to pneumatic vehicle tires, solid rubber tires, and two-wheel vehicle tires.

In particular, affecting the glass transition temperature of the rubber mixture used by selecting suitable polymer systems is frequently discussed in expert circles.

In this connection, it is known that the glass transition temperature of otherwise identical mixture components of two rubber mixtures is determined by the glass transition temperature of the polymer(s) used. The higher the glass transition temperature of a polymer, the higher the glass transition temperature of the rubber mixture as well, and the less favorable the rolling resistance behavior of the rubber mixture. Good indicators for the rolling resistance behavior of rubber mixtures are rebound resilience at 60 to 70° C. and hysteresis loss values, expressed by tan δ at 60 to 70° C.

It is generally known that 1,4-polybutadiene rubber has an extremely low glass transition temperature of approx. −105° C., which makes this rubber suitable for improving the rolling resistance behavior of rubber mixtures. However, it is also known that this considerably impairs the wet grip behavior of the rubber mixture.

Another known method of influencing tire properties such as abrasion, wet grip performance, and rolling resistance is the use of different styrene-butadiene copolymers with differing styrene and vinyl contents and differing modifications in the rubber mixtures, wherein the above-described problem of conflicting objectives arises in this case as well.

WO 2009/007167 A1 discloses the use of two different polymers with differing glass transition temperatures in order to improve wet grip.

Also for the purpose of improving wet grip, EP 0659821 A1 discloses the use of 20 to 80 phr of diene rubber, in this specific case natural rubber, and 80 to 20 phr of styrene-butadiene copolymer having a glass transition temperature between −50° C. and −25° C. The use of 10 to 50 phr of diene rubber, here styrene-butadiene rubber, having a glass transition temperature of less than −45° C. to improve the ratio of dry to wet gripping is described in EP 1253170 A1. In U.S. Pat. No. 6,812,288, on the other hand, 5 to 40 phr of styrene-butadiene copolymer having a glass transition temperature of −35° C. or higher and 95 to 60 phr of diolefin rubber having a glass transition temperature of −20° C. or less are used to improve the shock-adsorption properties (“vibration-isolating properties”) of the rubber mixture.

DE 40 01 822 C2 describes a rubber mass comprising 10 to 100 parts by weight of a solution-polymerized styrene-butadiene rubber having a vinyl content in butadiene of 20 to 70 wt % and a styrene content of 54.5 to 65 wt %, 0 to 90 parts by weight of an emulsion-polymerized styrene-butadiene rubber having a glass transition temperature of at least −60° C. and a styrene content of 20 to 65 wt %, and at least 70 parts by weight of carbon black, which are mixed into this rubber mass. This rubber mass is intended for use in running surfaces of high-performance tires with major hysteresis loss, high heat resistance, and a substantial grip.

U.S. Pat. No. 5,901,766 describes a pneumatic tire with a sulfur-vulcanizable composition that is characterized by containing 50 to 90 phr of a rubber having a glass transition temperature in the range of −80° C. to −110° C., 10 to 50 phr of at least one rubber having a glass transition temperature in the range of −79° C. to +20° C., and 15 to 50 phr of a resin. This mixture shows improved laboratory properties, which correlate with improved tire wear and concomitant improvement in grip (due to increased hysteresis loss) and road behavior.

However, the improvement in grip behavior due to increased hysteresis loss, that is, a greater tan δ at 0° C., is known to be accompanied by deterioration of rolling resistance properties, that is, shock adsorption during driving, which can be seen, for example, in U.S. Pat. No. 5,901,766 from the simultaneous increase in tan δ at 60° C. in ESBR and BR-containing rubber mixtures.

In order to optimize rolling resistance behavior or optimize various other properties of rubber mixtures that are relevant for use in tires without impairing rolling resistance behavior, the method is known of functionalizing the diene rubber used in such a way that binding to the filler(s) takes place.

Thus, for example, U.S. Pat. No. 8,450,424 discloses a rubber mixture that contains at least one aliphatic and/or aromatic hydrocarbon resin, at least one filler, and at least one functionalized diene rubber, whose functionalization takes place along and/or at the end of the polymer chain and allows binding to fillers, the diene rubber having a glass transition temperature T_{g} of −110 to −15° C. The hydroxy groups in Table 1 are disclosed as functionalizations for binding of the polymers to silica.

U.S. Pat. No. 8,426,512 discloses a rubber mixture that contains equal amounts of silica, carbon black, and functionalized polymers, with the use of 50 phr of amino-functionalized polybutadiene instead of 50 phr of unfunctionalized polybutadiene being disclosed inter alia. Such a rubber mixture shows improved rolling resistance indicators (rebound 100° C.), while the effect on tear properties, in particular tear propagation properties, is not disclosed in U.S. Pat. No. 8,426,512.

### SUMMARY OF THE INVENTION

It is therefore an object of the present invention to provide a rubber mixture which, when compared with the prior art, exhibits a further improvement of rolling resistance indicators, and at the same time improved tear properties.

This object is achieved by means of a rubber mixture containing the following constituents:
5 to 95 phr of at least one solution-polymerized styrene-butadiene rubber, which is amino-functionalized, has a styrene content of 0.1 to 12 wt %, and has a glass transition temperature in the unvulcanized state according to DSC of −75 to −120° C.,
5 to 95 phr of at least one further diene rubber, and
20 to 150 phr of at least one carbon black.

Surprisingly, when the rubber mixture is compared with the prior art it exhibits improved tear properties, in particular improved tear-propagation properties, and improved rolling resistance indicators.

The rubber mixture of the invention in particular exhibits, in comparison with the prior art, better abrasion resistance and improved rolling resistance performance when it comprises a blend of a solution-polymerized styrene-butadiene rubber (SSBR) with a comparatively high glass transition temperature T_{g} between −40° C. and +10° C. (high-T_{g}-SSBR) and an amino-functionalized solution-polymerized styrene-butadiene rubber described above with a glass transition temperatures T_{g} of −75 to −120° C. Prior art here is in particular considered to be a rubber mixture with the same glass transition temperature as the rubber mixture of the invention comprising a blend of low-T_{g} butadiene rubber known in the prior art with a high-T_{G}-SSBR.

The rubber mixture comprises at least one solution-polymerized styrene-butadiene rubber which has been amino-functionalized and which has a styrene content of 0.1 to 12 wt % and which has a glass transition temperature T_{g} according to DSC of −75 to −120° C. in the unvulcanized state. For the purposes of the present invention, amino-functionalized means that the rubber bears a plurality of amino groups along the polymer chain and/or bears one or more amino groups at the end of each polymer chain. It is also possible here that not every polymer chain has an amino group. The percentage by weight of amino-functionalized polymer chains is preferably 30 to 100 wt %, particularly preferably 50 to 100 wt %, and most particularly preferably 70 to 100 wt %.

The aforementioned solution-polymerized styrene-butadiene rubber shows in the unvulcanized state a glass transition temperature of −75° C. to −120° C., preferably −75 to −110° C., particularly preferably −80 to −110° C., and most particularly preferably −80° C. to −100° C., and can therefore be considered to be a styrene-butadiene rubber with a relatively low glass transition temperature.

In the rubber mixture according to the invention, this solution-polymerized styrene-butadiene rubber therefore replaces diene rubbers known in the prior art having a low glass transition temperature, in particular butadiene rubber (=BR, polybutadiene), while simultaneously improving rolling resistance behavior and tear properties.

The styrene content of the solution-polymerized styrene-butadiene rubber is 0.1 to 12 wt %, preferably 5 to 12 wt %, and particularly preferably 9 to 11 wt %, based on the total weight of the solution-polymerized styrene-butadiene rubber.

The solution-polymerized styrene-butadiene rubber preferably has a vinyl content with respect to the butadiene content of 1 to 30 wt %, preferably 1 to 15 wt %, particularly preferably 5 to 12 wt %, more particularly preferably 7 to 12 wt %, and even more particularly preferably 7 to 11 wt %. This allows a low glass transition temperature of the polymer to be achieved.

Determination of the styrene content and vinyl content of the polymers discussed in the scope of the present disclosure is carried out by ¹³C-NMR (solvent: deuterochloroform CDCl₃; NMR: “nuclear magnetic resonance”) and comparison with data from infrared spectrometry (IR; FT-IR spectrometer from the firm Nicolet, KBr window 25 mm in diameter×5 mm, 80 mg of sample in 5 mL of 1,2-dichlorobenzene). Determination of the glass transition temperature (T_{g}) is carried out by means of dynamic differential calorimetry (dynamic scanning calorimetry, DSC, according to DIN 53765: 1994-03 or ISO 11357-2: 1999-03, calibrated DSC with low-temperature device, calibration according to device type and manufacturer's instructions, sample in an aluminum crucible with an aluminum lid, cooling to temperatures lower than −120° C. at 10° C./min).

The unit used in this document of phr (parts per hundred parts of rubber by weight) is the unit commonly used in the rubber industry for indicating amounts in mixing recipes. The amounts in parts by weight of the individual substances given in this document refer to 100 parts by weight of the total weight of all high-molecular and thus solid rubbers present in the mixture.

The amounts of the solution-polymerized styrene-butadiene rubber mentioned present in the rubber mixture of the disclosure are 5 to 95 phr, preferably 20 to 95 phr, particularly preferably 51 to 95 phr, very particularly preferably 70 to 95 phr, and in turn very particularly preferably 80 to 95 phr.

According to another preferred embodiment of the disclosure, amounts of the solution-polymerized styrene-butadiene rubber present in the rubber mixture of the invention are 5 to 50 phr, particularly preferably 20 to 50 phr, very particularly preferably 30 to 40 phr.

The rubber mixture according to the disclosure also contains 5 to 80 phr, preferably 5 to 49 phr, particularly preferably 5 to 30 phr, and more particularly preferably 5 to 20 phr of at least one further diene rubber.

The at least one further rubber is in this case selected from the group consisting of natural polyisoprene and/or synthetic polyisoprene and/or butadiene rubber and/or solution-polymerized styrene-butadiene rubber and/or emulsion-polymerized styrene-butadiene rubber and/or liquid rubbers with a molecular weight Mw greater than 20,000 g/mol and/or halobutyl rubber and/or polynorbornene and/or isoprene-isobutylene copolymer and/or ethylene-propylene-diene rubber and/or nitrile rubber and/or chloroprene rubber and/or acrylate rubber and/or fluorine rubber and/or silicone rubber and/or polysulfide rubber and/or epichlorohydrin rubber and/or styrene-isoprene-butadiene terpolymer and/or hydrated acrylonitrile butadiene rubber and/or isoprene-butadiene copolymer and/or hydrated styrene-butadiene rubber.

In particular, nitrile rubber, hydrated acrylonitrile butadiene rubber, chloroprene rubber, butyl rubber, halobutyl rubber, or ethylene-propylene-diene rubber are used in the production of technical rubber articles such as straps, belts, and hoses.

Particularly preferably, the further diene rubber is selected from the group consisting of synthetic polyisoprene and natural polyisoprene and polybutadiene. Preferably, the further diene rubber is at least natural polyisoprene. This allows to achieve particularly favorable processability (extrudablity, miscibility, et cetera) of the rubber mixture.

According to a further preferred embodiment of the disclosure, the rubber mixture contains 10 to 70 phr of a conventional solution-polymerized styrene-butadiene rubber having a glass transition temperature of −40 to +10° C. (high-T_{g} SSBR) and 10 to 70 phr of the amino-functionalized styrene-butadiene rubber having a T_{g} of −120 to −75° C., preferably −110 to −75° C., particularly preferably −110 to −80° C., and most particularly preferably −87 to −80° C., with the rubber in this embodiment preferably having a styrene content of 1 to 12 wt %, particularly preferably 9 to 11 wt %, and most particularly preferably 10 to 11 wt %.

The rubber mixture may also contain at least one further diene rubber, in particular natural and/or synthetic polyisoprene.

When this type of rubber mixture is used to replace a conventional rubber mixture having the same glass transition temperature, it is possible to simultaneously increase the respective amount of high-T_{g} SSBR by using the described functionalized styrene-butadiene rubber having a T_{g} of −120 to −75° C., preferably −110 to −75° C., particularly preferably −110 to −80° C., and most particularly preferably −87 to −80° C.; this leads to a simultaneous improvement of rolling resistance performance and abrasion properties, and also of handling performance, while the other tire properties, in particular tear properties, remain at almost the same level or indeed are improved.

The rubber mixture of the disclosure comprises 20 to 150 phr, preferably 30 to 100 phr, particularly preferably 30 to 85 phr, of at least one carbon black as filler. It is possible here to use any of the types of carbon black known to the person skilled in the art. However, it is preferable to use a carbon black which has an iodine adsorption number according to ASTM D 1510 of 30 to 180 g/kg, preferably 40 to 180 g/kg, particularly preferably 40 to 130 g/kg, and a DBP number according to ASTM D 2414 of 80 to 200 ml/100 g, preferably 100 to 200 ml/100 g, particularly preferably 100 to 150 ml/100 g.

Particularly good rolling resistance indicators (rebound resilience at 70° C.) and tear properties are thus achieved for the application in vehicle tires. The rubber mixture can also comprise other known polar and/or nonpolar fillers, alongside carbon black.

It is preferable that the rubber mixture of the invention comprises carbon black as sole filler or as main filler, that is, the amount of carbon black is markedly greater than the amount of any other fillers present. If another filler is present alongside carbon black, it is preferable that this is silica. It is therefore also conceivable that the rubber mixture of the invention comprises similar amounts of carbon black and silica, for example 20 to 100 phr of carbon black combined with 20 to 100 phr of silica.

The silicas may be silicas known to the person skilled in the art that are suitable as fillers for tire rubber mixtures. However, it is particularly preferred to use a finely dispersed, precipitated silica having a nitrogen surface area (BET surface area) (according to DIN ISO 9277 and DIN 66132) of 35 to 350 m²/g, preferably 35 to 260 m²/g, particularly preferably 100 to 260 m²/g, and most particularly preferably 130 to 235 m²/g and a CTAB surface area (according to ASTM D 3765) of 30 to 400 m²/g, preferably 30 to 250 m²/g, particularly preferably 100 to 250 m²/g, and most particularly preferably 125 to 230 m²/g. Such silicas, when used, for example, in rubber mixtures for tire treads, produce particularly favorable physical properties of the vulcanizate. This can also provide advantages in mixture processing by reducing mixing time while retaining the same product properties, which leads to improved productivity. As silicas, one can both use, for example, those of the Ultrasil® VN3 type (brand name) from the firm Evonik and highly-dispersible silicas such as the aforementioned HD silicas (for example, Zeosil® 1165 MP from the firm Rhodia).

In order to improve processability and in order to bind the silica and other polar fillers that may be present to the diene rubber it is possible to use silane coupling agents in rubber mixtures. Here, one or a plurality of different silane coupling agents in combination with one another may be used. The rubber mixture may therefore contain a mixture of various silanes. The silane coupling agents react with the superficial silanol groups of the silica or other polar groups during the mixing of the rubber or of the rubber mixture (in situ), or even before adding the filler to the rubber as a pretreatment (premodification). All silane coupling agents known to the person skilled in the art as silane coupling agents for use in rubber mixtures may be used. Examples of conventional coupling agents are bifunctional organosilanes possessing at least one alkoxy, cycloalkoxy, or phenoxy group on the silicon atom as a leaving group, and as the other functionality, having a group that can optionally undergo a chemical reaction with the double bonds of the polymer after splitting. The latter group may, for example, constitute the following chemical groups:

SCN, —SH, —NH2 or -Sx- (where x=2 to 8).

As silane coupling agents, one can therefore use, for example, 3-mercaptopropyltriethoxysilane, 3-thiocyanato-propyl-trimethoxysilane, or 3,3′-bis(triethoxysilylpropyl)-polysulfide with 2 to 8 sulfur atoms such as, for example, 3,3′-bis(triethoxysilylpropyl)tetrasulfide (TESPT), the corresponding disulfide (TESPD), or mixtures of the sulfides with 1 to 8 sulfur atoms having a differing content of the various sulfides. For example, TESPT can also be added as a mixture with industrial carbon black (brand name X50S® from the firm Evonik).

Preferably, a silane mixture is used that contains up to 40 to 100 wt % of disulfides, particularly preferably 55 to 85 wt % of disulfides, and most particularly preferably 60 to 80 wt % of disulfides. This type of mixture, described by way of example in U.S. Pat. No. 8,252,863, is obtainable by way of example with the trademark Si 261® from Evonik. Blocked mercaptosilanes such as those known from WO 99/09036 can also be used as silane coupling agents. Silanes such as those described in U.S. Pat. Nos. 7,968,633; 7,968,634; 7,968,635; and, 7,968,636 may also be used. Suitable are, for example, silanes marketed under the name NXT in different variants by the firm Momentive, USA, or those marketed under the name VP Si 363® by the firm Evonik Industries.

Moreover, it is possible for the rubber mixture to contain carbon nanotubes (CNT), including discrete CNTs, so-called hollow carbon fibers (HCF), and modified CNT containing one or a plurality of functional groups such as hydroxy, carboxy, and carbonyl groups.

Graphite, graphene, and so-called “carbon-silica dual-phase fillers” are suitable as fillers.

Moreover, the rubber mixture may also contain other polar fillers, such as, for example, aluminosilicates, chalk, starch, magnesium oxide, titanium dioxide, or rubber gels.

However, it is particularly preferable that the rubber mixture is free from other fillers, that is, in this preferred embodiment the rubber mixture comprises 0 phr of any other filler. In this embodiment it is therefore not necessary to add any second filler.

For the purposes of the present invention, zinc oxide is not considered to be a filler.

The rubber mixture may also contain 0 to 70 phr, preferably 0.1 to 60 phr, and more preferably 0.1 to 50 phr of at least one plasticizer. These include all plasticizers known to the person skilled in the art, such as aromatic, naphthenic, or paraffinic mineral oil plasticizers, for example, MES (mild extraction solvate) or TDAE (treated distillated aromatic extract), rubber-to-liquid (RTL) oils or biomass-to-liquid (BTL) oils, factices, plasticizing resins, or liquid polymers (such as liquid BR), whose average molecular weight (determination by GPC=gel permeation chromatography, based on BS ISO 11344:2004), is between 500 and 20 000 g/mol. If liquid polymers are used in the rubber mixture according to the invention as plasticizers, these are not included as rubber in calculating the composition of the polymer matrix.

If a mineral oil is used, it is preferably selected from the group composed of DAE (distillated aromatic extracts) and/or RAE (residual aromatic extracts) and/or TDAE (treated distillated aromatic extracts) and/or MES (mild extracted solvents) and/or naphthenic oils.

Moreover, the rubber mixture according to the invention can contain common additives in the common number of parts by weight. These additives include

a) antioxidants such as, for example, N-phenyl-N′-(1,3-dimethylbutyl)-p-phenylene diamine (6PPD), N,N′-Diphenyl-p-phenylene diamine (DPPD), N,N′-ditolyl-p-phenylene diamine (DTPD), N-Isopropyl-N′-phenyl-p-phenylene diamine (IPPD), and 2,2,4-trimethyl-1,2-dihydroquinoline (TMQ),
b) activators such as, for example, zinc oxide and fatty acids (for example, stearic acid),
c) waxes,
d) resins, in particular adhesive resins,
e) mastication auxiliaries such as, for example, 2,2′-dibenzamidodiphenyldisulfide (DBD), and
f) processing auxiliaries, for example, fatty acid salts such as, for example, zinc soaps, fatty acid esters and derivatives thereof.

In particular, in the use of the rubber mixture according to the invention for the internal components of a tire or a technical rubber article that are in direct contact with the reinforcing supports present, a suitable adhesive system, often in the form of adhesive resins, is also generally added to the rubber.

The proportion of further additives contained in the entire amount is 3 to 150 phr, preferably 3 to 100 phr, and particularly preferably 5 to 80 phr.

The proportion of further additives contained in the entire amount also includes 0.1 to 10 phr, preferably 0.2 to 8 phr, and particularly preferably 0.2 to 4 phr of zinc oxide (ZnO).

This zinc oxide may be of any type known to the person skilled in the art, such as, for example, ZnO granulate or powder. Generally speaking, conventionally used zinc oxide shows a BET surface area of less than 10 m²/g. However, so-called nano zinc oxide having a BET surface area of 10 to 60 m²/g can also be used.

Vulcanization is carried out in the presence of sulfur or sulfur donors using vulcanization accelerators, with some vulcanization accelerators also being capable of acting as sulfur donors. Sulfur or sulfur donors and one or a plurality of accelerators are added in the last mixing step in the aforementioned amounts to the rubber mixture. Here, the accelerator is selected from the group composed of thiazole accelerators and/or mercapto accelerators and/or sulfenamide accelerators and/or thiocarbamate accelerators and/or thiuram accelerators and/or thiophosphate accelerators and/or thiourea accelerators and/or xanthogenate accelerators and/or guanidine accelerators.

A sulfenamide accelerator selected from the group composed of N-cyclohexyl-2-benzothiazole sufenamide (CBS) and/or N,N-dicyclohexylbenzothiazole-2-sulfenamide (DCBS) and/or benzothiazyl-2-sulfene morpholide (MBS) and/or N-tert-butyl-2-benzothiazyl sulfenamide (TBBS) is preferably used.

In a preferred embodiment of the invention the rubber mixture comprises CBS as accelerator. Particularly good tear properties are thus achieved for the rubber mixture.

Further network-forming systems such as for example those available under the brand names Vulkuren®, Duralink® or Perkalink®, or network-forming systems such as those described in WO 2010/059402, can also be used in the rubber mixture. This system contains a vulcanizing agent that crosslinks with a functionality greater than four and at least one vulcanization accelerator. The vulcanizing agent that crosslinks with a functionality greater than four has, for example, General Formula A):

G[CₐH₂ₐ—CH₂—S_{b}Y]_{c} A)

where G is a polyvalent cyclic hydrocarbon group and/or a polyvalent heterohydrocarbon group and/or a polyvalent siloxane group that contains 1 to 100 atoms; where each Y contains sulfur-containing functionalities independently selected from a rubber-active group; and where a, b and c are whole numbers for which the following applies independently: a equals 0 to 6; b equals 0 to 8; and c equals 3 to 5.

The rubber-active group is preferably selected from a thiosulfonate group, a dithiocarbamate group, a thiocarbonyl group, a mercapto group, a hydrocarbon group, and a sodium thiosulfonate group (colored salt group). This allows achievement of highly favorable abrasion and tear properties of the rubber mixture according to the invention.

Within the scope of the present disclosure, sulfur and sulfur donors, including sulfur-donating silanes such as TESPT, vulcanization accelerators as described above, and vulcanizing agents that crosslink with a functionality of greater than 4 as described in WO 2010/059402, such as, for example, a vulcanizing agent of Formula A), and the aforementioned systems Vulkuren®, Duralink®, and Perkalink®, are combined under the term vulcanizing agents.

The rubber mixture according to the disclosure preferably contains at least one of these vulcanizing agents; this makes it possible to produce vulcanizates, in particular for use in vehicle tires, from the rubber mixture according to the disclosure.

Vulcanization retarders may also be present in the rubber mixture.

A further object of the present invention is to provide a vehicle tire that exhibits improved rolling resistance behavior and improved tear properties, in particular increased tear propagation resistance. This object is achieved in that the vehicle tire contains the rubber mixture according to the disclosure in at least one component as described above. In this context, all of the aforementioned embodiments of the constituents and properties thereof apply.

Preferably, the component is a tread. As known to the person skilled in the art, the tread contributes to a relatively high degree to overall rolling resistance of the tire. In particular, high resistance to cracking and crack propagation in the tread is also advantageous.

Another object of the present disclosure is improving the rolling resistance performance and the tear properties of vehicle tires. According to the disclosure, this object is achieved through the use of the rubber mixture described above with all embodiments and features in vehicle tires, in particular in the tread of a vehicle tire, and/or a body mixture of a vehicle tire.

A further object of the disclosure is to optimize the abrasion behavior and the tear properties of technical rubber articles such as, for example, belts, straps, and hoses without having a significant negative effect on other properties that are relevant for the respective use.

This object is achieved by using the above-described rubber mixture for the production of technical rubber articles such as, for example, belts, straps and hoses.

The term body mixture as used here refers to rubber mixtures for the internal components of a tire. Internal tire components essentially include the squeegee, side wall, inner liner (inner layer), core profile, belt, shoulder, belt profile, carcass ply, bead wire, cable profile, horn profile, and bandage.

Manufacturing of the rubber mixture according to the invention is carried out by the methods commonly used in the rubber industry, in which a basic mixture with all of the constituents except the vulcanization system (sulfur and vulcanization-affecting substances) is first produced in one or a plurality of mixing stages. The finished mixture is produced by adding the vulcanization system in a last mixing stage. The finished mixture is further processed, for example, by means of an extrusion process, and given the corresponding form.

For use in vehicle tires, the mixture is preferably made into a tread and applied in the known manner in production of the vehicle tire blank. However, the tread can also be wound onto a tire blank in the form of a narrow rubber mixture strip. In two-part treads (upper part: cap and lower part: base), the rubber mixture according to the disclosure can be used both for the cap and for the base.

Manufacturing of the rubber mixture according to the disclosure for use as a body mixture in vehicle tires is carried out as described above for the tread. The difference lies in the molding after the extrusion process. The forms of the rubber mixture according to the disclosure obtained in this manner for one or a plurality of various body mixtures are then used to produce a tire blank. In order to use the rubber mixture according to the disclosure in belts and straps, in particular in conveyor belts, the extruded mixture is made into the corresponding form and, at the same time or thereafter, often provided with reinforcing supports, for example, synthetic fibers or steel cords. In most cases, one obtains a multilayer structure composed of one and/or a plurality of layers of the rubber mixture, one and/or a plurality of layers of the same and/or different reinforcing supports, and one and/or a plurality of further layers of the same and/or another rubber mixture.

In use of the rubber mixture according to the disclosure in hoses, peroxide crosslinking is frequently preferred to the aforementioned sulfur crosslinking.

Manufacturing of the hoses is carried out analogously to the method described in Handbuch der Kautschuktechnologie [Handbook of Rubber Technology], Dr. Gupta Verlag, 2001, Chapter 13.4. DESCRIPTION OF THE PREFERRED EMBODIMENTS OF THE INVENTION

The disclosure will now be explained in further detail by means of the comparative examples and exemplary embodiments summarized in Table 1. The comparison mixtures are indicated by “V”, and the mixtures according to the invention are indicated by “E”.

Mixture production was carried out under the usual conditions in three stages in a laboratory tangential mixer. Test pieces were produced from all of the mixtures by optimal vulcanization under pressure at 160° C., and these test pieces were used to determine the material properties typical for the rubber industry by using the test methods given below.
Shore A hardness at room temperature (RT) according to DIN 150 7619-1
Rebound resilience at 70° C. according to DIN 53 512
Tensile strength, elongation at break, and 300% static elongation modulus (modulus 300) at room temperature according to DIN 53 504
High-velocity elongation at break as tear energy per unit of deformed volume at room temperature according to the High Speed Tear Energy Test (HSTE) according to DIN 10 045
Tear-propagation resistance according to Graves at 100° C. by a method based on ISO 34 1, in each case arithmetic of the average values at one temperature over test samples punched out parallel to and perpendicular to the direction of rolling
Abrasion at room temperature according to DIN53 516 or DIN/ISO 4649
Glass transition temperature T_{g} of the rubber mixture (mixture T_{g}) from the loss factor tan δ (tangent delta) by dynamic mechanical measurement according to DIN 53 513 (temperature sweep)

TABLE 1

| | Unit | V1 | E1 | V2 | E2 |
|---|---|---|---|---|---|
| Constituents | | | | | |
| BR^{a)} | phr | 90 | — | 40 | — |
| SSBR^{b)} | phr | — | 90 | — | 35 |
| SSBR^{c)} | phr | — | — | 50 | — |
| SSBR^{d)} | phr | — | — | — | 55 |
| NR: TSR | phr | 10 | 10 | 10 | 10 |
| Carbon black N339 | phr | 85 | 85 | 85 | 85 |
| TDAE | phr | 45 | 45 | 45 | 45 |
| Antioxidant | phr | 4 | 4 | 4 | 4 |
| Stearic acid | phr | 2.5 | 2.5 | 2.5 | 2.5 |
| ZnO | phr | 2.5 | 2.5 | 2.5 | 2.5 |
| Accelerator CBS | phr | 2 | 2 | 2 | 2 |
| Sulfur | phr | 2 | 2 | 2 | 2 |
| Physical properties | | | | | |
| Shore hardness RT | Shore A | 63 | 64 | 63 | 61 |
| Rebound elasticity | % | 53 | 55 | 45 | 49 |
| 70° C. | | | | | |
| Tensile strength | MPa | 13 | 14 | 12 | 13 |
| Elongation at break | % | 356 | 343 | 376 | 380 |
| Modulus 300 | MPa | 11 | 13 | 10 | 11 |
| HSTE | MJ/m³ | 3 | 3.5 | — | — |
| Graves at 100° C. | N/mm | 22 | 31 | — | — |
| T_{g} | ° C. | — | — | −26 | −24 |
| Abrasion | Mm³ | — | — | 120 | 119 |

Substances used from Table 1:
^{a)}BR: polybutadiene, high-cis, Nd-catalyzed butadiene rubber, unfunctionalized, T_{g} = −105° C., Europrene ® NEOCIS BR 40, Polimeri
^{b)}SSBR: styrene content = 10 wt %, vinyl content = 9 wt %, T_{g} = −83° C., functionalized with amino groups
^{c)}SSBR: styrene content = 24 wt %, vinyl content = 67 wt %, T_{g} = 18° C., Buna VSL 5025. LanXess
^{d)}SSBR: styrene content = 21 wt %, vinyl content = 64 wt %, T_{g} = −21° C., Nipol ® NS 116, Nippon Zeon

As can be seen from Table 1, replacement of butadiene rubber with low T_{g} as in comparative mixture V1 by an SSBR functionalized by amino groups with a styrene content of 10 wt %, and a T_{g} of −83° C. in the rubber mixture E1 of the invention leads to a) an increase of stiffness as indicator of improved handling, b) increased rebound resilience at 70° C. as indicator of improved rolling resistance performance, and c) increased values for tear-propagation resistance and high-velocity elongation at break as tear energy per unit of deformed volume as indicator of improved tear properties in use in a vehicle.

From comparison of V2 with E2 it can be seen that the rubber mixture E2 of the invention exhibits improved rolling resistance performance and improved abrasion properties, and improved handling, for almost identical T_{g} of the mixture.

The use of the amino-functionalized SSBR with comparatively low glass transition temperature in the rubber mixture E2 of the invention at the same time permits use of a higher proportion of high-T_{g} SSBR.

It is understood that the foregoing description is that of the preferred embodiments of the invention and that various changes and modifications may be made thereto without departing from the spirit and scope of the invention as defined in the appended claims.

What is claimed is:

1. A sulfur-crosslinkable rubber mixture comprising:
5 to 95 phr of at least one solution-polymerized styrene-butadiene rubber, which is amino-functionalized, has a styrene content of 0.1 to 12 wt %, and has a glass transition temperature in the unvulcanized state according to DSC of −75 to −120° C.,
5 to 95 phr of at least one further diene rubber, and
20 to 150 phr of at least one carbon black.

2. The sulfur-crosslinkable rubber mixture as claimed in claim 1, further comprising:
10 to 70 phr of the amino-functionalized styrene-butadiene rubber with a T_{g} of −75 to 120° C., and
from 10 to 70 phr of a solution-polymerized styrene-butadiene rubber with a glass transition temperature of −40 to +10° C.

3. The sulfur-crosslinkable rubber mixture as claimed in claim 1, wherein the glass transition temperature of the solution-polymerized amino-functionalized styrene-butadiene rubber in the unvulcanized state is −80 to −110° C.

4. The sulfur-crosslinkable rubber mixture as claimed in claim 1, wherein the solution-polymerized amino-functionalized styrene-butadiene rubber has a vinyl content of 7 to 12 wt %.

5. The sulfur-crosslinkable rubber mixture as claimed in claim 1, wherein the at least one carbon black has an iodine adsorption number according to ASTM D 1510 of 30 to 180 g/kg and a DBP number according to ASTM D 2414 of 80 to 200 ml/100 g.

6. The sulfur-crosslinkable rubber mixture as claimed in claim 1, wherein the rubber mixture is free from silica.

7. A vehicle tire comprising the sulfur-crosslinkable rubber mixture as claimed in claim 1 in at least one component.

8. The vehicle tire as claimed in claim 7, wherein the component is a tread and/or a side wall.

9. A method of manufacturing a vehicle tire comprising preparing the rubber mixture as claimed in claim 1.

10. A method of manufacturing a strap, belt, or hose comprising preparing the rubber mixture as claimed in claim 1.
